(19) United States
(12) Patent Application Publication
(10) Pub. No.: US 2023/0415348 A1
(43) Pub. Date: Dec. 28, 2023

(54) METHOD AND SYSTEM FOR IMAGE PROCESSING USING A VISION PIPELINE

(71) Applicant: APERA Al INC., Vancouver (CA)

(72) Inventors: Sina AFROOZE, Vancouver (CA); Ralph William Graeme JOHNS, Vancouver (CA)

(21) Appl. No.: 18/037,517

(22) PCT Filed: Nov. 19, 2021
(86) PCT No.: PCT/CA2021/051643

§ 371 Date: May 17, 2023

Related U.S. Application Data
(60) Provisional application No. 63/115,066, filed on Nov. 18, 2020.

(51) Int. Cl. B25J 9/16

(52) U.S. Cl. CPC B25J 9/1697; B25J 9/1664; B25J 9/161

(57) ABSTRACT

Methods, systems, and techniques for image processing using a vision pipeline. A first image is obtained by a vison processor from a camera. The vision processor processes the first image using a vision pipeline. The vision pipeline includes a group of connected processing nodes, and at least one of the nodes relies on an asset to perform a processing task based on the first image. Pre-configured assets corresponding to various configurations may be deployed to multiple vision processors using a shared asset repository, thereby facilitating deployment and customization at scale.

### TECHNICAL FIELD

The present disclosure is directed at methods, systems, and techniques for image processing using a vision pipeline.

### BACKGROUND

Image processing refers generally to computational processing performed on data contained in an image. Image processing is one aspect of vision guided robotic automation, in which a camera captures an image, that image is processed, and the results of that processing inform the movements of a robot. For example, a car assembly line may use a camera to capture an image of a panel on an automobile, that image may then be processed, and the results of that processing may guide a robotic welder to weld that panel.

In certain situations, image processing can require significant computational resources in terms, for example, of processing power and storage space.

### SUMMARY

According to a first aspect, there is provided a method comprising: obtaining a first image from a first camera; and processing the first image in a first vision pipeline, wherein the first vision pipeline comprises a first group of connected processing nodes, and at least one of the nodes relies on an asset to perform a processing task based on the first image.

The method may further comprise moving a first robot in response to the processing performed by the first vision pipeline.

The asset may comprise a packaged file, the packaged file may comprise an asset descriptor, and the asset descriptor may comprise an asset identifier, an asset type identifier, and a payload.

The payload may comprise a neural network definition and associated weights.

The payload may comprise configuration parameters for the at least one of the nodes.

The configuration parameters may comprise at least one other asset identifier identifying at least one other asset.

The at least one other asset may comprise additional configuration parameters for the at least one of the nodes.

The configuration parameters of the payload may further comprise non-asset identifier parameters.

The asset identifier may be globally unique.

The method may further comprise processing the image in a second vision pipeline. The second vision pipeline may comprise a second group of connected processing nodes, at least one of the nodes of the second group may perform a processing task based on the first image, and the second vision pipeline may perform processing on an output of the first vision pipeline.

The method may further comprise processing the image in at least one additional vision pipeline, each of the at least one additional vision pipeline may comprise an additional group of connected processing nodes, and at least one of the nodes of each of the at least one additional vision pipeline may perform a processing task based on the first image, and the first vision pipeline and the at least one additional vision pipeline may be connected in series.

The vision pipelines may be collectively identified using a chained pipeline identifier.

The method may further comprise processing the image in a second vision pipeline. The second vision pipeline may comprise a second group of connected processing nodes, at least one of the nodes of the second group may perform a processing task based on the first image or on a second image, and the second vision pipeline may perform processing on the first image or on the second image in parallel with the first vision pipeline. The first and second vision pipelines may be collectively identified using a pipeline group identifier.

The method may further comprise processing the image in at least one additional vision pipeline, each of the at least one additional vision pipeline may comprise an additional group of connected processing nodes, at least one of the nodes of each of the at least one additional vision pipeline may perform a processing task based on the first image or on an image different from the first image, and the first vision pipeline and the at least one additional vision pipeline may be connected in parallel.

The first vision pipeline and the at least one additional vision pipeline may be collectively identified using a pipeline group identifier.

The processing may be performed using a first vision processor, and the asset may be retrieved from an asset repository accessible by the first vision processor and at least one other vision processor.

The asset repository may store at least one other asset for the at least one other vision processor.

The asset may be stored in a hashed path in the asset repository.

The asset may be one or both of encrypted and digitally signed when stored in the asset repository.

A configuration of the first vision pipeline may be stored in a configuration file.

The method may further comprise storing different versions of the configuration file respectively specifying different states of the assets at different times.

The different versions of the configuration file may be managed using a distributed version control system.

The method may further comprise: retrieving a version of the configuration file representing a past system configuration; and reverting to the past system configuration.

The different versions of the configuration file that correspond to different schema for the configuration file may be managed using the first distributed version control system and may respectively stored using different named-branches of the first distributed version control system.

The method may further comprise retrieving a particular one of the different versions of the configuration file by checking out a tip of the named-branch used to store the particular one of the different versions of the configuration file.

The first distributed version control system may be stored in a local repository and the different versions of the configuration file may also managed using a second distributed version control system stored in a cloud repository, the different versions of the configuration file managed using the second distributed version control system may be respectively stored using different named-branches of the second distributed version control system and respectively correspond to different schema for the configuration file, and the method may further comprise: determining that a particular one of the different versions of the configuration file is unavailable in the local repository and available in the cloud repository; and retrieving the particular one of the different versions of the configuration file by checking out a tip of the named-branch of the second distributed version control system used to store the particular one of the different versions of the configuration file.

None of the named-branches may store a desired version of the configuration file, and the method may further comprise: upgrading a schema of one of the different versions of the configuration file to the desired version of the configuration file; creating a new named-branch in the first distributed version control system; and committing the desired version of the configuration file as the new named-branch.

The method may further comprise committing a new version of the configuration file as a new commit of an existing one of the named-branches of the first distributed version control system, and a commit author of the new commit may be based on an identity of a system user and on an identity of a representative of the system manufacturer.

The method may further comprise pushing the new commit to a second distributed version control system residing in a cloud repository.

The asset repository may be stored as a cloud repository and different versions of the assets may be stored in the cloud repository.

The method may further comprise maintaining a journal log of system launch configurations, the journal log for each of the system launch configurations may comprise a software version, a commit hash of a configuration repository, a duration of each run, and whether the software initialized completely.

The method may further comprise: retrieving one of the system launch configurations representing a past system launch configuration; and reverting to the past system launch configuration.

At least two of the nodes of the first vision pipeline may be collectively referenced in the configuration file as a pre-configured asset.

All of the nodes of the first vision pipeline may be collectively referenced in the configuration file as the pre-configured asset.

The method may further comprise: receiving from a robot controller a call to perform the processing; receiving from the robot controller a first identifier of one of the nodes; and returning to the robot controller an output of the node identified by the first identifier that results from the processing.

The node identified by the first identifier may be upstream of a final node of the vision pipeline, and the method may further comprise: receiving from the robot controller a second identifier identifying the final node; and returning to the robot controller an output of the final node that results from the processing.

According to another aspect, there is provided a system comprising: a first camera; a vision processor communicatively coupled to the first camera and to obtain a first image therefrom; a robot; and a robot controller communicatively coupled to the robot and to the vision processor, wherein the robot controller is configured to cause the vision processor to perform any of the foregoing aspects of the method or suitable combinations thereof.

According to another aspect, there is provided a method comprising storing in or retrieving from a first configuration file repository a version of a configuration file for a configurable system, wherein the first configuration file repository stores at least some different versions of the configuration file using a first distributed version control system that respectively stores different versions of the configuration file that correspond to different schema for the configuration file in different named-branches of the first distributed version control system.

A version of the configuration file representing a past configuration of the configurable system may be retrieved, and the method may further comprise reverting the configurable system to the past system configuration.

A particular one of the different versions of the configuration file may be retrieved from the repository by checking out a tip of the named-branch used to store the particular one of the different versions of the configuration file.

The first configuration file repository may be a local repository and the different versions of the configuration file may also be managed using a second distributed version control system stored in a cloud repository, the different versions of the configuration file managed using the second distributed version control system may be respectively stored using different named-branches of the second distributed version control system and respectively correspond to different schema for the configuration file, and the method may further comprise: determining that a particular one of the different versions of the configuration file is unavailable in the local repository and available in the cloud repository; and retrieving the particular one of the different versions of the configuration file by checking out a tip of the named-branch of the second distributed version control system used to store the particular one of the different versions of the configuration file.

None of the named-branches may store a desired version of the configuration file, and the method may further comprise: upgrading a schema of one of the different versions of the configuration file to the desired version of the configuration file; creating a new named-branch in the first distributed version control system; and committing the desired version of the configuration file as the new named-branch.

The method may further comprise committing a new version of the configuration file as a new commit of an existing one of the named-branches of the first distributed version control system, a commit author of the new commit may be based on an identity of a user of the configurable system and on an identity of an administrator of the configuration repository.

The method may further comprising pushing the new commit to a second distributed version control system residing in a cloud repository.

According to another aspect, there is provided a system comprising: a processor; a network interface communicatively coupled to the processor; a memory communicatively coupled to the processor, the memory having computer program code stored thereon that is executable by the processor and that, when executed by the processor, causes the processor to perform the method of any of the foregoing aspects or suitable combinations thereof.

According to another aspect, there is provided a non-transitory computer readable medium having encoded thereon computer program code that is executable by a processor and that, when executed by the processor, causes the processor to perform any of the foregoing aspects of the method or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a system for image processing using a vision pipeline, according to an example embodiment in which the system comprises a single robot cell.

FIGS. 2A-2C depict various robot cells having different camera arrangements for respective use in additional example embodiments of a system for image processing using a vision pipeline.

FIG. 3 depicts a system for image processing using a vision pipeline, according to an example embodiment in which the system comprises three robot cells.

FIG. 4 depicts a block diagram of a vision processor for use with a system for image processing using a vision pipeline, according to an example embodiment.

FIG. 5 depicts a method for image processing using a vision pipeline, according to an example embodiment.

FIG. 6 depicts an example vision pipeline for execution by a system for image processing using a vision pipeline, according to an example embodiment.

FIG. 7 depicts a group of chained vision pipelines for execution by a system for image processing using a vision pipeline, according to an example embodiment.

FIG. 8 depicts a group of vision pipelines for parallel execution by a system for image processing using a vision pipeline, according to an example embodiment.

### DETAILED DESCRIPTION

A system that performs vision guided robotic automation typically comprises a robot cell. In the context of a vision guided system, a robot cell comprises a sensor in the form of a camera; a part feeding component such as a conveyor belt, grid, or bin; a robot, comprising for example an end effector in the form of a gripper or welder; and a robot controller that controls the robot. A vision guided robotic automation system may comprise several robot cells. Conventional vision guided robotic automation systems are typically designed such that attempting to use them in a flexible and scalable way is made difficult by a variety of technical problems.

For example, a robot cell may be required to perform several different vision tasks, with the different tasks having some dependency on each other. One vision task may be to draw on an image a bounding box around a part in a bin, for example, while a subsequent task may be to crop that bounding box from the remainder of the image. Conventionally, configuring such tasks for execution by different robot cells at scale is manually done, and is consequently inefficient, error prone, and time consuming.

As another example, different robot cells may each be performing the same task in a variety of contexts. For example, multiple robot cells in a production plant may all need to perform object detection. Some of those robot cells may perform object detection in identical contexts (e.g., each cell may detect the same type of object at the same point in a workflow), while some other robot cells may perform them in different contexts (e.g., other cells may detect different types of objects, or identical objects at different points in a workflow). A change to how the object detection task is performed is conventionally manually updated across all robot cells. Given the number of robot cells, this again represents a relatively inefficient, error prone, and time consuming procedure.

Additionally, certain vision tasks are computationally quite expensive and consequently take a relatively long time to compute. Naïve implementation, in which a vision task is performed without the benefit of configuration data specific to the context in which the task is being applied, does not help reduce the computational cost of performing the task. And, conventionally, configuring each task is manually done at scale. This is a significant disincentive to ensuring a proper initial configuration, and to periodically revising configurations to facilitate efficient performance.

In contrast, according to at least some of the example embodiments described herein, the vision tasks performed by a robot cell are represented as “nodes” that can be joined to generate a “vision pipeline”. Any one or more of the nodes may rely on any one or more “assets” that provides a particular type of functionality. A system comprises a robot controller communicative with a vision processor, with the robot controller requesting that the vision processor execute the vision pipeline. Each of the assets may be stored in an asset repository that is shared by multiple vision processors of the system and/or by multiple systems. The asset repository may be updated from time-to-time as assets are added to, removed from, or updated in the repository, thereby facilitating deployment of assets at scale. One or more assets configured in a particular way may itself comprise a type of pre-configured asset (referred to interchangeably herein as a “configuration pre-set asset” or “compute-collection asset”); encapsulating an asset and a particular configuration in this way facilitates scale and flexibility in deployment. Additionally, configuration information for the system may from time-to-time be stored in a configuration file that is saved in a configuration repository. The configuration file stores the state of the nodes in the vision pipeline (including any configuration pre-set assets), with multiple configurations representing states of the nodes at different times. This permits the nodes to be reverted to an earlier state, which can be useful if an upgrade or other system change prejudices performance. The configuration repository may store multiple configuration files or versions thereof for a single system; additionally or alternatively, the configuration repository may be shared between multiple systems and accordingly share one or more configuration files or versions thereof for any one or more of those multiple systems.

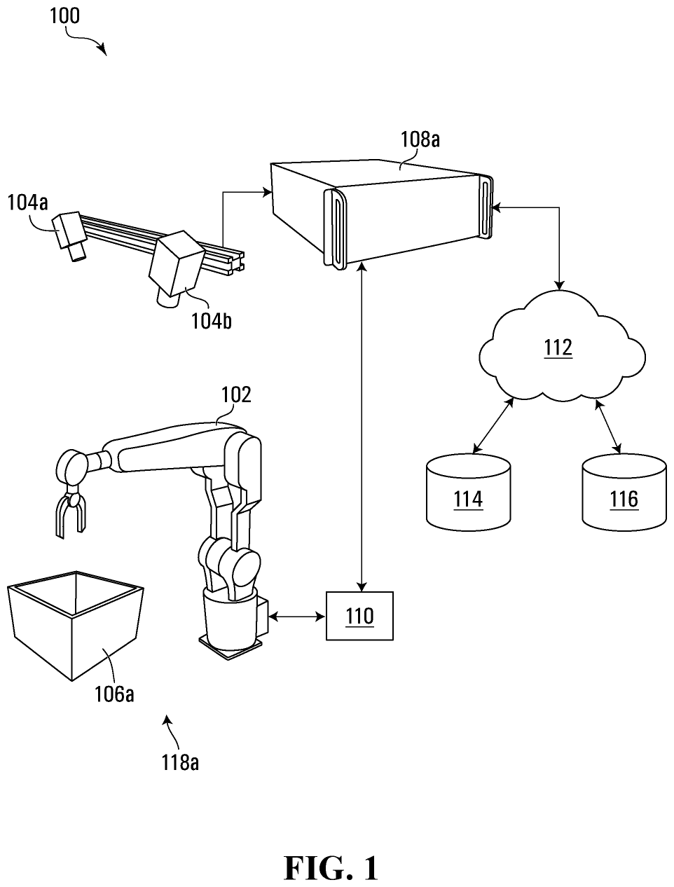

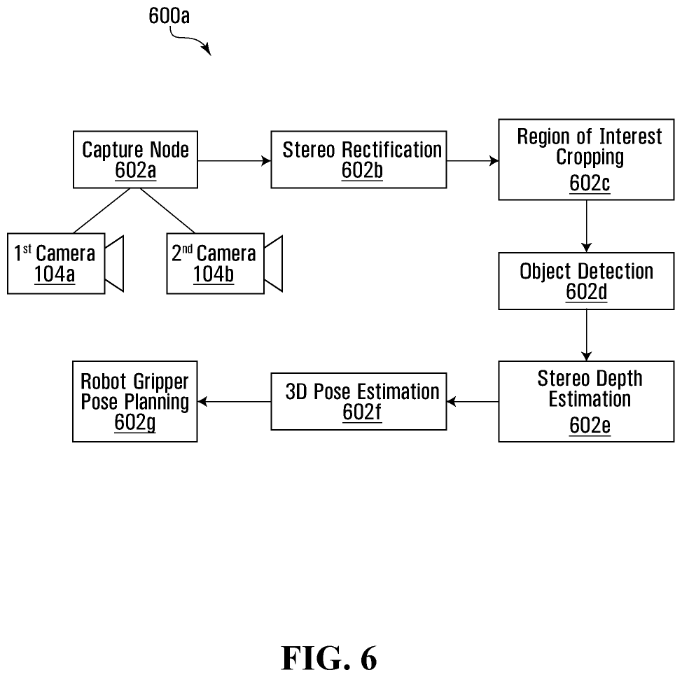

Referring now to FIG. 1, there is shown a system 100 for image processing using a vision pipeline, according to an example embodiment. The system comprises a first robot cell 118a, which itself comprises a first bin 106a; a robot 102; a robot controller 110 communicatively coupled to the robot 102, and first and second cameras 104a,b that permit capture of a first stereo image pair. The robot controller 110 and the cameras 104a,b are communicatively coupled to a first vision processor 108a. When the robot cell 118a is performing a task using the robot 102 (e.g., picking up a particular component from the bin 106a) and a vision related task is to be performed, the robot controller 110 calls on the vision processor 108a to perform the task by executing a vision pipeline (discussed further below in respect of FIGS. 6-8). The vision processor 108a executes the vision pipeline asynchronously in response to this call, and may asynchronously return or wait for the robot controller 110 to subsequently call to retrieve the one or more results of the initial call.

As mentioned above, the assets that comprise the vision pipeline are stored in an asset repository 114. The assets may be stored in a hashed path in the asset repository 114, thereby providing security by making it practically impossible to guess the directory path even if the directory path is public. The vision processor 108a is networked through a wide area network 112, such as the Internet, to the asset repository 114. The asset repository 114 may accordingly be a cloud repository. Also as mentioned above, the vision processor 108a is networked through the network 112 to a configuration repository 116 that is used to store various configurations of the system 100.

FIG. 1 shows the robot controller 110 and cameras 104a,b as being directly connected to the vision processor 108a, and the vision processor 108a as being networked to the repositories via the wide area network 112. In at least some different example embodiments (not depicted), these components may be communicative with each other in any suitable alternative way. For example, the robot controller 110 and cameras 104a,b may be connected to the vision processor 108a via an Ethernet™ connection, and one or both of the repositories 114, 116 may similarly be connected to the vision processor 108a using a local area network. In another example, each of these components may be connected to the other using the Internet.

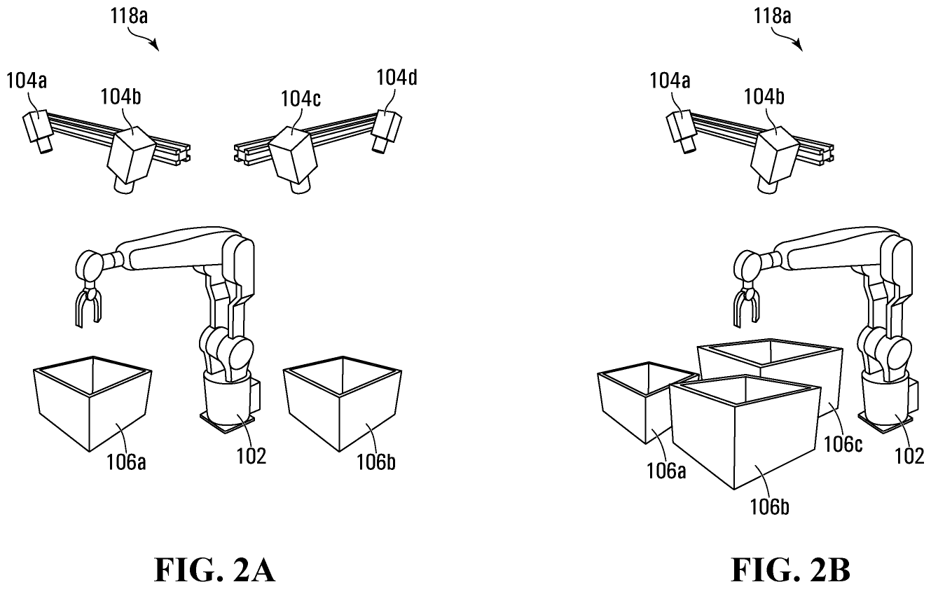

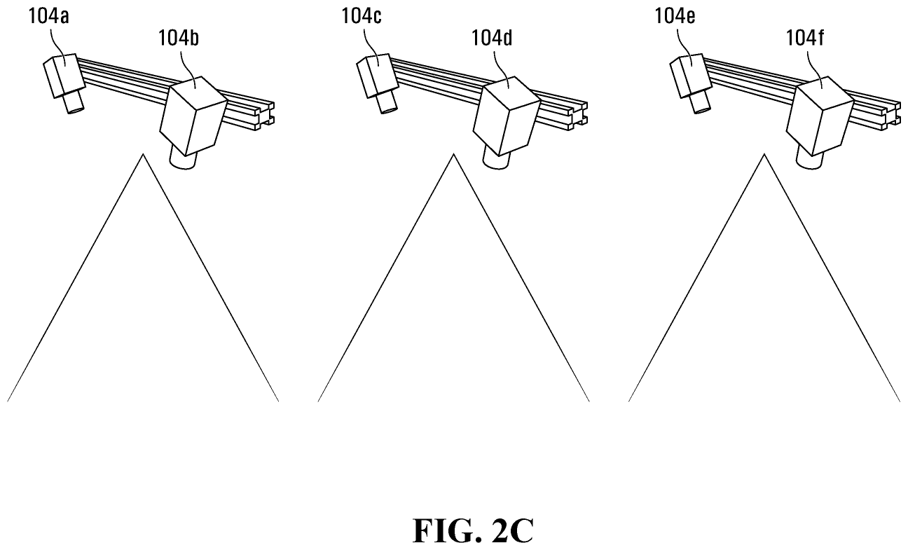

While FIG. 1 shows the robot cell 118a comprising the first and second cameras 104a,b focused on the first bin 106a, different camera arrangements are possible in different example embodiments. FIG. 2A, for example, depicts the first and second cameras 104a,b focusing on the first bin 106a, and depicts third and fourth cameras 104c,d focusing on a second bin 106b. This permits the vision processor 108a to obtain the first image pair from the first and second cameras 104a,b, a second and non-overlapping image pair from the third and fourth cameras 104c,d, and the robot controller 110 to cause the robot 102 to manipulate objects from either of the bins 106a,b in response. As another example, in FIG. 2B the first and second cameras 104a,b image the first and second bins 106a,b and a third bin 106c. The first and second cameras 104a,b generate a single image pair with three different regions of interest respectively corresponding to the three bins 106a-c. Depending on the nodes executed by the vision processor 108a when executing a vision pipeline, the vision processor 108a may assess different objects in the different regions of interest, and the robot controller 110 may cause the robot 102 to interact with objects in any of those regions accordingly. In FIG. 2C, fifth and sixth cameras 104e,f are used in addition to the first through fourth cameras 104a-d to image three areas that are adjacent to and non-overlapping with each other. The effect of this camera positioning is to generate three image pairs that can be combined to effectively form a single, large image pair with a larger region of interest than can be produced with fewer cameras.

Different cameras may be additionally or alternatively mounted. For example, instead of pairs of 2D cameras used to generate 3D images as depicted in FIGS. 2A-2C, a single 2D camera may be used instead of camera pairs when 3D information is not needed; a single 3D camera may be used instead of a camera pair even when 3D information is needed; a camera pair may be mounted to the robot's end of arm tooling; and/or a single camera may be mounted to the robot's end of arm tooling.

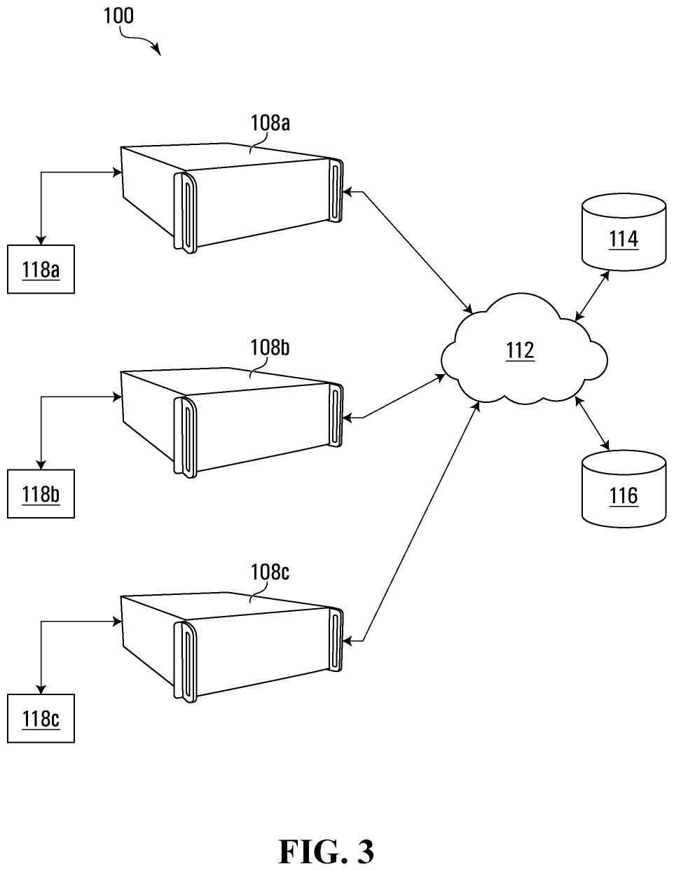

FIG. 3 depicts another example of the system 100 for image processing using a vision pipeline. In FIG. 3, the system 100 comprises the first vision processor 108a and second and third vision processors 108b,c, each of which is communicatively coupled to the asset repository 114 and configuration repository 116 through the network 112. The first vision processor 108a is communicatively coupled to the first robot cell 118a as in FIG. 1, and the second and third vision processors 108b,c are analogously respectively communicatively coupled to second and third robot cells 118b,c. Each of the vision processors 108a-c is accordingly able to access the configuration files and the assets used by the other of the vision processors 108a-c. As discussed further below, this permits particular asset configurations to easily be shared across the different robot cells 118a-c. This also permits assets to be easily upgraded or changed across the robot cells 118a-c, as the assets (including any configuration pre-set assets) may be changed once in the asset repository 114 and then automatically used to execute vision pipelines by the vision processors 108a-c.

In FIG. 3, the asset repository 114 and configuration repository 116 are both shared by the three vision processors 108a-c. In at least some other embodiments (not depicted), while the asset repository 114 is shared by all the vision processors 108a-c, each of the vision processors 108a-c has its own configuration repository. In further embodiments (not depicted), the asset repository 114 is shared by multiple systems 100, while each of the systems 100 comprises one or more configuration repositories 116 not shared with other systems 100; a particular system 100 may, for example, have a configuration repository 116 for each of the vision processors 108a-c comprising part of that system 100. Sharing the asset repository 114 in this manner allows assets (including pre-configured assets) to be created by a system manufacturer, system integrator, or other service provider, and pushed to different customers managing different systems 100, as described further below.

As with FIG. 1 above, despite the robot cells 118a-c being shown as directly respectively connected to the vision processors 108a-c and the vision processors 108a-c being connected through the network 112 to the repositories 114, 116, in at least some other embodiments (not depicted) any suitable alternative connections may be used.

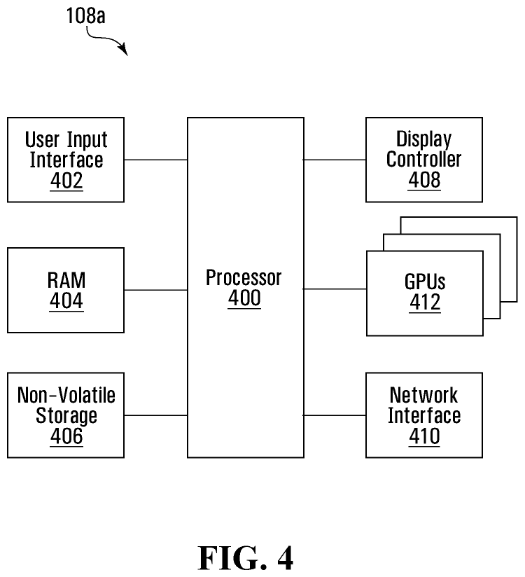

Referring now to FIG. 4, there is shown a block diagram of the first vision processor 108a, which is identical to the second and third vision processors 108b,c, according to an example embodiment. In FIG. 4, the first vision processor 108a comprises a processor 400 that controls the vision processor's 108a overall operation. The processor 400 is communicatively coupled to and controls subsystems comprising a user input interface 402, to which any one or more user input devices such as a keyboard, mouse, touch screen, and microphone may be connected; random access memory (“RAM”) 404, which stores computer program code that is executed at runtime by the processor 400; non-volatile storage 406 (e.g., a solid state drive or magnetic spinning drive), which stores the computer program code loaded into the RAM 404 for execution at runtime and other data; a display controller 408, which may be communicatively coupled to and control a display (not shown); graphical processing units (“GPUs”) 412, used for parallelized processing as is not uncommon in vision processing tasks and related artificial intelligence operations; and a network interface 410, which facilitates network communications with and via the network 112, the cameras 102a,b, and the robot controller 110. While FIG. 4 depicts the first vision processor 108a, an analogous system and typically less computationally powerful system (e.g., omitting the GPUs 412 and with a less powerful processor 400) is used for the robot controller 110.

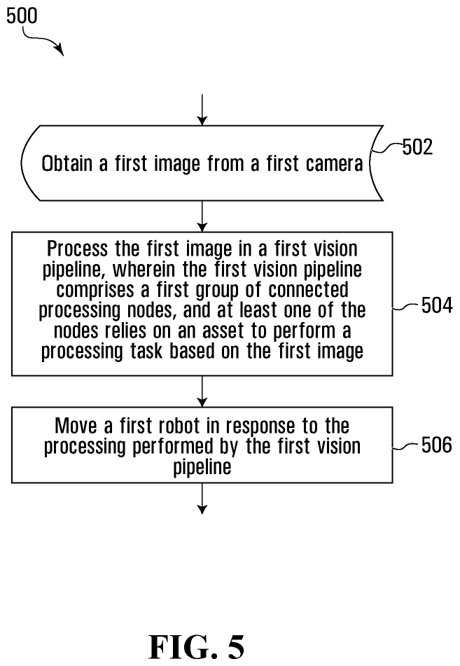

Referring now to FIG. 5, there is shown a method 500 for image processing using a vision pipeline, according to another example embodiment. At block 502, a first image is obtained from the first camera 102a. The first vision processor 108a may obtain the first image directly from the first camera 102a, and obtaining the first image may comprise part of obtaining a first image pair from the first and second cameras 102a,b. After obtaining the first image, the vision processor 108a processes the first image in a first vision pipeline at block 504. This may be done in response to a call from the robot controller 110 to do so. The first vision pipeline comprises a first group of connected processing nodes, with each of the nodes configured to produce and/or process data, and output data to one or both of another node or to return a result to an entity outside of the vision pipeline such as the robot controller 110. At least one of the nodes comprises one or more assets that partially or completely specify the node's configuration, and that the node leverages when performing its data generation and/or processing. For example, and as discussed in further detail below, an asset may comprise one or more libraries or a neural network definition used for image processing. The node may directly process the first image, or may indirectly process the first image by performing processing on the output of a node that directly processed the first image. Once the processing is complete, the robot 102 is moved in response to the processing at block 506. This may comprise, for example, the vision processor 108a returning the result of robot controller's 110 call to execute the vision pipeline (e.g., the result may be a particular robot 102 gripper position in response to image processing), and the robot controller 110 may cause the robot 102 to accordingly move. The method 500 of FIG. 5 and variations thereto as described further below may be encoded as computer program code, stored in a non-transitory computer readable medium such as the non-volatile storage 406, be loaded into the RAM 404 and executed by the processor 400 and GPUs 412 at runtime.

Generally, a vision pipeline comprises a directed graph of data processing nodes, typically starting with a node producing image data and ending with 2D or 3D position data. Referring now to FIG. 6, there is shown a first vision pipeline 600a for object pose estimation using stereoscopic depth estimation, according to an example embodiment. The vision pipeline 600a comprises seven nodes 602a-g connected in series, with the output of the first through sixth nodes 602a-f serving as the input of the second through seventh nodes 602b-g. The first and second cameras 104a,b output a stereo image pair that serves as the input to the first node 602a.

Each of the nodes 602a-g performs a specific task. In FIG. 6, the first node 602a captures the stereo image pair, which comprises defining camera parameters of the image capture (e.g., exposure, gain, bit depth) and performing basic processing (e.g., gamma correction, multi-exposure fusion, underexposure/overexposure adjustment); the second node 602b performs stereo rectification on the image pair; the third node 602c crops the region of interest from the image pair; the fourth node 602d performs object detection on the cropped region of interest; the fifth node 602e performs stereo depth estimation on the detected object; the sixth node 602f performs 3D pose estimation on the detected object; and the seventh node 602g determines a gripper position of the robot 102 based on the 3D pose of the detected object. The vision processor 108a executes the vision pipeline 600a in response to a call from the robot controller 110, and returns to the robot controller 110 the robot 102 gripper pose as determined by the seventh node 602g. The robot controller 110 then moves the robot 102 accordingly.

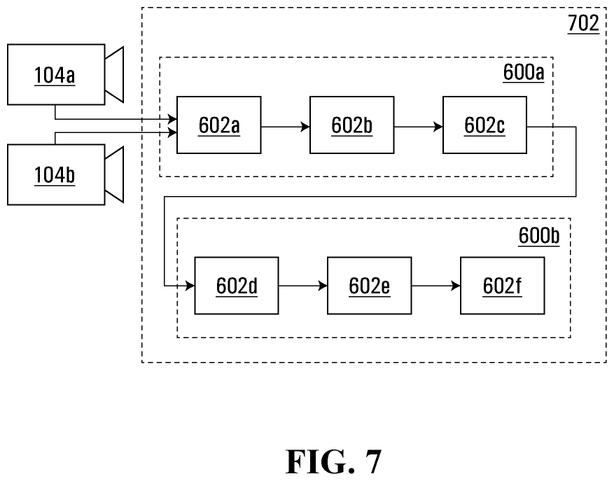

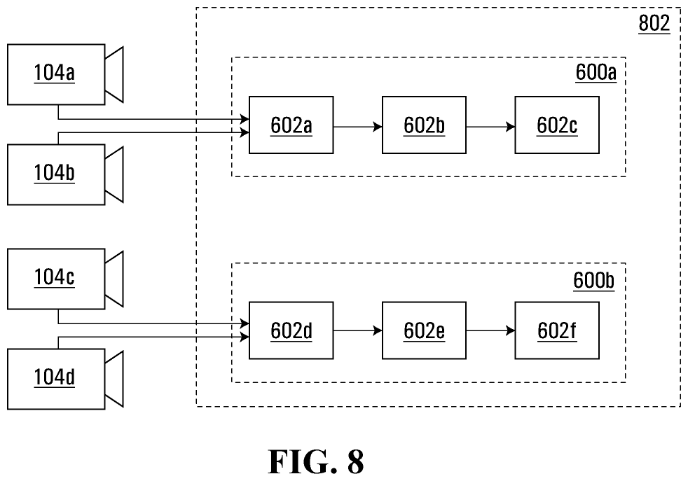

From the perspective of a user of the system 100, each of the nodes 602a-g represents the smallest testable and reusable data processing component of the system 100; the vision pipeline 600a represents a larger data processing component comprising an integration of nodes 602a-g; and, as discussed further below in respect of FIGS. 7 and 8, various vision pipelines may be grouped for the purpose of achieving full automation. While the vision pipeline 600a in FIG. 6 shows the nodes 602a-g connected in series, in at least some other embodiments (not depicted) the nodes 602a-g may be connected in any suitable way (e.g., the vision pipeline 600a comprise loops and/or branches of nodes 602a-g).

Each of the assets comprises a packaged file (e.g., a .zip file, .tar file, a proprietary format, or another suitable format) that comprises an asset descriptor. While the following discussion focuses on the asset incorporated into the fourth node 602d for object detection, it is applicable more generally to an asset that may be incorporated into any of the nodes 602a-g.

The asset descriptor comprises a globally unique identifier (“GUID”) for the node 602d and an asset type identifier. The asset's GUID may be used to call out a dependency on the asset and to retrieve the asset from the asset repository 114. In at least some example embodiments, the asset comprises a .zip file that comprises two files:
1. asset.json: asset.json is the asset descriptor in the JSON file format. The asset descriptor comprises the asset's GUID, the asset type identifier, and, a payload. An example asset descriptor in the JSON file format follows:

```
{
  “type”:“detector”,
  “id”:“project_20080501_detector_v1.3.2”,
  ”detector”:
  {
    “file_name”:“detector.trace”,
    “input_resolution”:“500x500”
  }
}
```

2. detector.trace: A neural network definition and associated weights of the object detector in a suitable file format.

In this example, “detector” is the asset type identifier, “project_20080501_detector_v1.3.2” is the GUID, and the “detector” section of asset.json as well as the detector.trace file are the asset's payload. In this example, the asset's detector.trace payload is referenced in asset.json by file name; in at least some other examples (not depicted), parts of the asset's payload may be directly reproduced in the asset.json file itself.

As alluded to above, in at least some example embodiments one asset (“parent asset”) may be dependent on one or more other assets (each a “child asset”). The parent asset accordingly relies on the functionality of the child asset. A dependency is specified by referencing the GUID of the one or more child assets on which the parent asset is dependent in the payload section of the asset.json file for the parent asset. For example, the configuration pre-set asset may be the parent asset, and it may reference one or more child assets, as discussed below.

Different types of the vision pipeline 600a may exist. Example tasks performed by various embodiments of the vision pipeline 600a comprise stereo 3D object pose estimation, 2D object pose estimation, 3D object defect detection, and 2D object defect detection. Each vision pipeline type comprises a template that allows a system configurator, such as the end user, a system integrator, or a manufacturer, to choose the various nodes 602a-g comprising the pipeline 600a. Having pre-defined vision pipeline types simplifies configuration by the user and simplifies complex data flows between various nodes 602a-g in the pipeline 600a.

While the first vision pipeline 600a of FIG. 6 is used for object pose estimation, vision pipelines may be used for different purposes. For example, a vision pipeline may be used for object inspection. When used for inspection, the pipeline's output may be a binary 0 or 1 representing inspection pass/fail; additionally or alternatively, the pipeline when used for inspection may output a set of values related to the inspection, such as measurements of a feature of the object being inspected.

Referring now to FIG. 7, there is depicted the first vision pipeline 600a and a second vision pipeline 600b chained together in another example embodiment such that the vision processor 108a executes the second vision pipeline 600b using the result of the execution of the first vision pipeline 600a. In FIG. 7, the first and second cameras 104a,b send an image pair to the first node 602a, which outputs data to the second node 602b, which outputs data to the third node 602c, which outputs the result of the first vision pipeline 600a. The output of the first vision pipeline 600a is used as the input to the fourth node 602d, which is the first node of the second vision pipeline 600b. The fourth asset's 602d output is the input to the fifth node 602e, whose output is the input to the sixth node 602f, whose output is the result of the second vision pipeline 600b. In FIG. 7, each of the vision pipelines 600a,b has its own identifier (“ID”), and the pipelines 600a,b collectively form a chained pipeline 702 that has its own ID. For example, the chained pipeline 702 of FIG. 7 may be used when the first vision pipeline 600a is tasked with creating a 2D bounding box to find a bin of parts on a table, and to crop the image of the bounding box. The cropped image output of the first vision pipeline 600a is fed to the second vision pipeline 600b, which performs the task of 3D part post estimation to guide the robot 102 to pick the part. Multiple chained vision pipeline types may exist, each providing a template for different pipelines in a chain, as well as the data transport between the pipelines.

While the examples of FIGS. 6 and 7 depict a single pair of cameras 104a,b as the shared image sources for the pipelines 600a,b, in at least some example embodiments the system 100 may comprise multiple vision pipelines 600a,b with separate imaging sources, or multiple image sources in a single one of the pipelines 600a,b. FIG. 8, for example, depicts the first through fourth cameras 104a-d used in conjunction with the pipelines 600a,b.

Referring now to FIG. 8, there is depicted the first and second vision pipelines 600a,b grouped together to form a vision pipeline group 802. In FIG. 8, the first and second cameras 104a,b provide a first stereo image pair to the first vision pipeline 600a, while the third and fourth cameras 104c,d provide a second stereo image pair to the second vision pipeline 600b. The vision pipeline group 802 facilitates triggering of multiple vision pipelines, and in the depicted example the first and second pipelines 600a,b, concurrently. Concurrent execution using the vision pipeline group 802 may be useful, for example, when multiple of the cameras 104a-f are to capture images simultaneously so as to minimize vision delay. As with the vision pipelines 600a,b themselves and the chained pipeline 702, the vision pipeline group 802 has its own ID that may be specifically called by the robot controller 110. In at least some example embodiments, the vision pipelines 600a,b of the pipeline group 802 may share the same capture node, with the output of the capture node being fed to all of the vision pipelines 600a,b of the group 802. The vision processors 108a-c may execute the vision pipelines 600a,b in parallel using a thread pool, for example. Execution of certain of the nodes 602a-g may be accelerated using specialized multi-threaded libraries such as the Intel™ MKL-DNN library or specialized hardware such as Nvidia™ GPUs together with specialized libraries such as CUDA and CUDNN.

In at least some example embodiments, the ID for the chained and grouped pipelines 702, 802 are unique only for a particular system 100 while the GUID for the assets is globally unique, while in other example embodiments both types of identifiers may be globally unique, neither may be globally unique, or the identifier for the chained and grouped pipelines 702, 802 may be globally unique while the identifiers for the assets are not.

In the examples of the vision pipelines 600a,b described above, the vision processors 108a-c may return one or more results to the robot controller 110 in response to the call to execute the vision pipelines 600a,b. For example, the vision processors 108a-c may return a single result after execution of all of the nodes 602a-g is complete, one or more intermediate results that is the output of any of the nodes 602a,b,d,e upstream of the final nodes 602c,g comprising the pipelines 600a,b or a combination thereof. For example, the robot controller 110 may include in its call to the vision processors 108a-c only the ID of the first vision pipeline 600a if that is what is to be executed, or the ID of the chained pipeline 702 if the result of the second pipeline 600b based on the first pipeline 600a is desired. As another example of fetching an intermediate result, if the first vision pipeline 600a is tasked with performing stereo 3D object pose estimation, the pipeline 600a may initially estimate the pose of the object using only 2D information, which can then be used as an input for 3D pose registration. However, the estimated pose using the 2D information is available before the 3D information and the robot controller 110 may consequently fetch the 2D information by referencing the UID of the node 602a-g that output the 2D data. The robot controller 110 can then position the robot 102 suitable in the robot cell 118a, near the object to be picked, and ready to more precisely position itself to pick up the object once the 3D information is returned. In at least some example embodiments, the robot controller 110 may call by ID the chained pipeline 702, pipeline group 802, or the pipelines 600a,b comprising them, which asynchronously triggers the chained pipeline 702, pipeline group 802, or individual pipelines 600a,b that are called. The call from the robot controller 110 is immediately returned, acknowledging that the robot controller 110 has successfully called the chained pipeline 702, pipeline group 802, or individual pipelines 600a,b. Following that acknowledgement, the robot controller 110 may fetch the result by making a subsequent call that references that ID of the node 602a-g that outputs the desired result.

As discussed above, the assets are stored in the asset repository 114. An example of the asset repository 114 is the Amazon S3™ service. In at least some example embodiments, the assets are encrypted, which protects any confidential or proprietary information they contain (e.g., a 3D model of an object). The vision processors 108a-c decrypt any encrypted assets required to execute the vision pipeline 600a. Decryption keys are stored in an asymmetrically encrypted digital keychain file generated for each of the vision processors 108a-c. A keychain file maps a dictionary of asset GUIDs to decryption keys that may, for example, be stored in a JSON format. The vision processors 108a-c may download the keychain file from a server (e.g., from a vendor of the system 100) after successfully authenticating themselves. In at least some example embodiments, the assets stored in the repository 114 may additionally or alternatively be digitally signed by their creator so that the vision processors 108a-c can confirm the assets' authenticity prior to executing the vision pipeline 600a.

In at least some example embodiments, the asset repository 114 is entirely or partially cached by intermediate servers (not shown) between the vision processor 108a and the network 112 for network performance or security reasons. For example, a company that is a user of the system 100 may decide to cache all of the assets comprising part of any vision pipelines 600a,b on which they rely in an intranet server, and re-direct their vision processors 108a-c to download any assets from the intranet server as opposed to accessing the asset repository 114 through the Internet.

Additionally, in at least some example embodiments, access to particular assets may not be universally granted to all of the vision processors 108a-c. For example, a first company may own the first vision processor 108a and a second company may own the second and third vision processors 108b,c, with the second vision processor 108b being deployed by a first business unit and the third vision processor 108c being deployed by a second business unit. Access to each of the assets stored in the asset repository 114 may be conditioned on authentication using an asset deployment database (not shown), which specifies which of the vision processors 108a-c has permission to download (or cache, as described above) which of the assets. In this example, the asset deployment database may specify that each of the three different vision processors 108a-c is permissioned to be able download different subsets of the assets from the asset repository 114, thereby ensuring that the first and second companies cannot download each other's assets, and that the first and second business units of the second company cannot download each other's assets.

As another example, the assets may respectively be associated with unique URLs that are used to download the assets. Each of the URLs may comprise a hash string (e.g., generated by hashing the content of the asset with which the URL is associated using the SHA256 hash function), which statistically makes the URL impossible to guess. This URL may then be shared only with the vision processors 108a-c and organizations that are to have access to the associated asset.

In at least some example embodiments, a user may wish to specify particular configurations for one or more of the assets, and to save those one or more assets accordingly pre-configured for future use as one or more configuration pre-set assets, as mentioned above. Configuration pre-set assets may be shared across multiple vision processors 108a-c and multiple systems 100 (e.g., for each of the assets, by using only that asset's unique identifier) by using only the assets' respective unique identifiers, thereby facilitating customized configurations at scale. In one example, a configuration pre-set asset may be created from a subset of the overall system configuration (e.g., the configuration pre-set asset based on the seventh node 602g of FIG. 6 directed at robot gripper pose may specify a list of preferred picking poses for a specific type of object). A configuration pre-set asset may otherwise be treated analogously as any other asset; for example, they may be encrypted, may have a GUID, cached on an intranet, uploaded to the asset repository 114, downloaded using a unique URL, and shared across vision processors 108a-c and systems 100.

In addition to pre-configuring certain assets, as mentioned above a user of the system 100 may store an overall system configuration storing states of all or part of the system 100 at different times in a configuration file that is stored in the configuration repository 116. As used herein, reference to “a configuration file” includes a reference to a single configuration file that specifies system configuration and to more than one configuration file that collectively specify system configuration. Example parameters stored in the configuration file comprise a list of active vision pipelines 600a,b, the cameras 102a-f used with the pipelines 600a,b, calibration information for each of the cameras 102a-f, calibration information for the robot 102, and preferred picking locations for particular objects. Different configurations may be stored in different versions of the configuration file, and the different versions may be managed using a version control system; more particularly, different schema for the configuration file may be respectively stored using different versions of the configuration file. For example, a distributed version control system such as git may be used to manage different versions of the configuration file that are stored in the configuration repository 116. Each system 100 or combination of vision processors 108a-c therein may have its own configuration repository 116. Backups of the configuration repository 116 may be made from time-to-time to a service such as the Amazon AWS CodeCommit™ managed source control service. In at least some example embodiments, any configuration changes performed using the system's 100 user interface are immediately committed to the configuration repository 116 using the version control system to avoid having different and incompatible local forks of the configuration file. In the event of modifications to the configuration file done outside of the system's 100 user interface (e.g., a modification may be done manually via a text editor launched from the command line), the appropriate one of the vision processors 108a-c is configured to commit those modifications to the configuration repository 116 immediately following a system restart. As mentioned above, in at least some example embodiments each of the vision processors 108a-c may be associated with its own configuration repository 116, and the configuration file for those processors 108a-c are respectively stored in those repositories 116.

A managed source control service such as Amazon AWS CodeCommit™, can be used by the system manufacturer to push configuration updates to any one or more of the vision processors 108a-c. These updates can be done in realtime while, for example, a user of the system is receiving live support from a person who has control of the configuration repository, such as the manufacturer's customer support person. Additionally or alternatively, new updates, for example in the form of updates to a vision pipeline configuration, can be selectively pushed to any one or more of the vision processors 108a-c as a configuration update by, for example, the manufacturer. For example, when any one of the vision processors 108a-c running software notices a configuration update is available for the current named-branch, it may notify the user or automatically apply the update by it from the configuration repository 116. The user's identification (for example, the user's username) and the identification of a person who has control of the configuration repository (e.g., a customer support person) may collectively be used to generate an identity of the commit author for the repository 116. This allows changes to the repository 116 to be traced back to the persons responsible for the changes, which is valuable for auditing purposes.

The named-branch feature of a distributed version control system such as git can be used to separate configuration file format (as used herein, the “format” of the configuration file is interchangeably referred to as its “schema”) changes to address the problem of format compatibility breakage. When upgrading system software such that a new format for the configuration file will be required and if a named-branch for that new format does not yet exist, the system upgrade script can upgrade the configuration file to that new format and use the version control system to create a new named-branch for the updated version of the configuration file in the configuration repository 116. Alternatively, if a named-branch for the format required by the new version of the system software already exists, the system upgrade script can check out the configuration file for that named-branch. Alternatively, a manufacturer or service provider for the system 100 can upgrade the configuration file to the new format, push the updated configuration file as a new version to the configuration repository 116, store the new version as a new named-branch of the configuration file using the version control system, and then the vision processors 108a-c can pull the new version of the configuration file from the repository 116.

Within the distributed version control system, some different versions of the configuration file may share the same format, while other different versions of the configuration file may share different formats (e.g., one version of the configuration file may use a schema that permits specification of the gain of a camera using the variable “gain”, while another version of the configuration file may use a schema that has no way of specifying a camera's gain). Even if different versions of the configuration file share the same format, they may specify different values for identical configuration parameters (e.g., one version of the configuration file may specify a gain of 1, while another version of the configuration file may specify a gain of 1.5). To track different versions, some of which may use incompatible schema, in at least some embodiments the distributed version control system may use different named-branches for versions of the configuration file that use different schema, while an update to a version of the configuration file that uses the same schema as the immediately preceding version of the configuration file may be stored along the same named-branch. For example, if version 1.0 of a configuration file requires “gain” to be specified, and in fact specifies gain as 3, the user may change the gain to 3.5 and commit that change to the distributed version control system, which remains identified as version 1.0 of the configuration file and is identified as different from an earlier iteration of version 1.0 by a unique commit hash for the update. Practically, to update version 1.0 in this manner, a user may check out the tip of the named-branch that stores version 1.0 of the configuration file, update the value of gain from 3 to 3.5, and then commit the updated version 1.0 of the file back to the distributed version control system to the end of the named-branch that stores version 1.0. The user may also push this new commit to another distributed version control system that may reside on a different machine or the cloud for backup and/or for the system manufacturer's access to the latest active configuration of the system.

Continuing with this example, the user may then check out the tip of the named-branch that stores version 1.0 of the configuration file and replace “gain” with “am_gain” that specifies a particular gain value to use before noon and “pm_gain” that specifies a different gain value to use after noon. This represents a schema change relative to the schema used for version 1.0 of the configuration file; accordingly, this version of the schema may be named version 2.0 and is stored as a new named-branch in the distributed version control system.

Some changes may be backwards compatible while other changes may not be backwards compatible. As an example of this and building on the previous example, version 1.0 of a configuration file schema may specify “gain” while version 1.2 of the configuration file may specify “gain” and also permit specification of a camera's exposure using the variable “exposure”. Here, a system configured to use version 1.2 may also be backwards compatible with version 1.0 on the basis that specifying “exposure” is permitted but not required by the schema. Regardless, because they are different schema, versions 1.0 and 1.2 of the configuration file are stored in different named-branches of the distributed version control system. Changing configuration file schema may be done, for example, using a script that upgrades the schema from one version to another desired version; following this upgrade, the new version may be stored in a new named-branch of the distributed version control system.

The configuration repository 116 may be stored locally to the vision processors 108a-c (e.g., accessible to the vision processors 108a-c via a LAN or directly connected to the vision processors 108a-c), and/or be stored remotely (e.g., accessible to the vision processors 108a-c over a wide area network, such as in the cloud). Some versions of the configuration files may accordingly be stored in a local configuration repository, while the same and/or other versions may be backed-up or otherwise stored in a cloud-based configuration repository. Both the local and cloud-based configuration repositories may use a distributed version control system. The cloud-based repository may, for example, be administered by a third party such as the vision processors' 108a-c manufacturer. The vision processors 108a-c may access either the local or cloud-based repository. For example, the vision processors 108a-c may determine that a particular one of the different versions of the configuration file is unavailable in the local repository and available in the cloud repository, and retrieve the particular one of the different versions of the configuration file by checking out a tip of the named-branch of the second distributed version control system used to store the particular one of the different versions of the configuration file.

In at least some example embodiments, the vision processors 108a-c maintain a journal log file stored in a log file repository outside of the configuration repository 116, with the log file including details of all system launches, including the version of the software run as well as the hash of the configuration file at the time it was committed to the configuration repository 116, a hash of the configuration repository 116 itself at the time the configuration file was committed to it, and other associated metadata such as whether the system initialized successfully, system uptime duration, and the number of vision requests served by the vision processors 108a-c (i.e., the number of vision pipelines 600a,b executed by the vision processors 108a-c in response to calls from the robot controller 110). In the event of system instability following, for example, a change in configuration or a software upgrade, the system 100 can accordingly be restored to an earlier and stable software build and configuration state selectable from the log file. For example, the log file may reference a software version and hash of a particular version of the configuration file that was stable at a previous point in time, and the vision processors 108a-c may revert to the system state based on that software version and configuration file. Alternatively, the vision processors 108a-c may retrieve a version of the configuration file representing a past system configuration independently of retrieving the journal log file or any other data referenced or contained in the journal log file, and revert to the configuration referenced in the retrieved configuration file.

The backups of the configuration file in the configuration repository 116 and any backups of the log file, which are stored outside of the configuration repository 116 (e.g., in the Amazon S3™ service), can be accessed by the system manufacturer to provide support. The system manufacturer may push new versions of configuration files to the configuration repository 116 where the vision processors 108a-c may retrieve them.

While the examples above contemplate use of configuration files and the configuration repository 116 in the context of the vision processors 108a-c, more generally the use of configuration files may be analogously applied to any configurable system that uses configuration files. The use, for example, of the distributed version control system and/or local and cloud-based repositories can be used to facilitate configuration of systems other than the vision processors 108a-c.

In at least some example embodiments, in order to simplify deployment of the assets and modification of related system configurations, users of the system 100 may respectively be assigned administrative accounts from which they can log into a system management portal (not depicted) via a web browser to see all of their available assets that can be deployed, those assets that have been deployed in various vision pipelines 600a,b, and all the various system configurations as embodied in various versions of the configuration file associated with those users. For each of the users, virtual groups may be created in the management portal to easily deploy various assets and perform batch configuration modifications to those groups. The virtual groups may be within a single system 100, or span multiple systems 100. Users may trigger a virtual group-wide system upgrade once they have finished making changes to their assets and configurations.

### Examples

In at least some example embodiments, as an alternative to storing some or all configuration parameters in the configuration file, they may be stored in one or more configuration pre-set assets. For example, a service provider may wish to push a particular configuration for the vision pipeline 600a to a customer and, for the sake of protecting the know-how represented by a specific set of configuration parameters, only wish to update the customer's vision processor 108a by adding a reference to a configuration pre-set asset's GUID. By embedding the configuration parameters within the configuration pre-set asset, only the configuration pre-set asset's GUID need be updated as opposed to other parameters. As another example, a system integrator may wish to share a particular configuration across multiple vision processors 108a-c and/or customers. In this example, the system integrator may embed certain configuration parameters into the configuration pre-set asset and push the configuration pre-set asset to the asset repository 114 to make it available to multiple vision processors 108a-c and/or customers. Those vision processors 108a-c and/or customers may then rely on the configuration pre-set asset's GUID when incorporating that configuration as opposed to having to make a larger number of changes to the configuration file. The following are examples of files specifying particular assets (including configuration pre-set assets), vision pipelines 600a,b, and configuration files that take advantage of this flexibility.

An example depth neural network asset is packaged in a tar-ball file, asset_generic_depth_v1.tar, and comprises the following asset.json file. In this example, the depth network asset's type identifier is “depth”, its GUID is “asset_generic_depth_v1”, and its payload is the “depth” section of the asset.json file. As described above in respect of detector.trace, the tar-ball file would also comprise depth.trace itself.

```
/ / depth network asset has two files: asset.json and depth.trace
/ / asset.json content
{
  “type”:“depth”,
  “id”:“asset_generic_depth_v1”,
  “depth”: {
    “file_name”: “depth.trace ”,
    “max_disparity”:“1024”
  }
}
```

An example detector neural network asset is packaged in a tar-ball file, asset_project_20080501_detector_v2.tar, and comprises the following asset.json file. In this example, the detector asset's type identifier is “detector”, its GUID is “asset_project_20080501_detector_v2”, and its payload is specified in the “detector” section of the asset.json file. The tar-ball file would also comprise detector.trace itself.

```
/ / detector network asset has two files: asset.json and
detector.trace
/ / asset.json content
{
  “type”:“detector”,
  “id”:“asset_project_20080501_detector_v2”,
  “detector”: {
    “file_name”:“detector.trace ”,
    “input_resolution”:“500x500”
  }
}
```

An example CAD model asset is packaged in a tar-ball file, asset_project20080501_part_a_cad_v1.tar, and comprises the following asset.json file. In this example, the CAD model asset's type identifier is “cad”, its GUID is “asset_project_20080501_part_a_cad_v1”, and its payload comprises a.stl. The tar-ball file itself would also comprise a.stl.

```
/ / CAD file asset has two files: asset.json and a.stl
{
  “type”:“cad”,
  “id” “asset_project_20080501_part_a_cad_v1”,
  “mask”: {
    “file_name”: “a.stl”
  }
}
```

An example configuration file (“initial configuration file”) comprises the following JSON file. It specifies the first through seventh nodes 602a-g for a “3d_pick_part_A” vision pipeline 600a in the “vision_pipelines” section: a “type” node named “3d_pose”; a “capture” node named “cap_node_1”; an“roi” node named “roi_node_1”; a“depth” node named “depth_node_1”; a “part_detector” node named “detector_node_1”; a “pose” node named “pose_node_1”; and a “grip_planner” node named “grip_planner_node_1”. Following the “vision_pipelines” section, the initial configuration file specifies particular configuration parameters for the nodes 602a-g. More particularly, the “data-nodes” section specifies configuration parameters for the cap_node_1 node, roi_node_1 node, depth_node_1 node, detector_node_1 node, pose_node_1 node, and grip_planner_node_1 node in the “captures”, “rois”, “depth_estimators”, “part_detectors”, “pose_estimators”, and “grip_planners” section of the initial configuration file, respectively. In particular, the configuration parameters specify that node “depth_node_1” comprises the “asset_generic_depth_v1” asset referenced above; node “detector_node_1” comprises the “asset_project_20080501_detector_v2” asset referenced above; and node “pose_node_1” comprises the “asset_project_20080501_part_a_cad_v1” asset referenced above. The end of the initial configuration file also specifies the port used for communicating with, and the type of, the robot 102 in the “robot_server” section.

```
{
  “vision_pipelines”: {
    “3d_pick part_A”: {
      “type”: “3d_pose”,
      “capture”: “cap_node_1”,
      “roi”: “roi_node_1”,
      “depth”: “depth_node_1”,
      “part_detector”: “detector_node_1”,
      “pose”: “pose_node_1”,
      “grip_planner”: “grip_planner_node_1”,
    }
  },
  “data-nodes”: {
    “captures”: {
      “cap_node_1”: {
        “capture_mode”: “single_shot”,
        “exposure_ms”: 30,
        “primary_camera_serial”: “123”,
        “secondary_camera_serial”: “124”
      }
    },
    “rois”: {
      “roi_node_1”: {
        “roi_x”: 300,
        “roi_y”: 184,
        “roi_w”: 2302,
        “roi_h”: 3591
      }
    } ,
    “depth_estimators”: {
      “depth_node_1”: {
        “depth_network”: “asset_generic_depth_v1”,
        “normalization”: “global”,
        “tile_dimension”: 200
      }
    },
    “part_detectors”: {
      “detector_node_1”: {
        “detector_network”:
“asset_project_20080501_detector_v2”,
        “max_objects”: 4
      }
    },
    “pose_estimators”: {
      “pose_node_1”: {
        “model”:
“asset_project_20080501_part_a_cad_v1”,
        “point_match_threshold”: 0.002
      }
    } ,
    “grip_planners”: {
      “grip_planner_node_1”: {
        “planner_type”: “simple”,
        “pick_point”: {
          “p_deg”: 90.0,
          “r_deg”: 0.0,
          “w_deg”: 0.0,
          “x_m”: −0.01,
          “y_m”: 0.0,
          “z_m”: 0.0
        }
      }
    }
  } ,
  “robot_server”: {
    “port”: 14040,
    “robot_type”: “fanuc”
  }
}
```

The following shows how the initial configuration file can be simplified by using configuration pre-set assets.

First, an image capture configuration pre-set asset is created with a GUID of “asset_project_20080501_capture_preset_v1”. This asset's payload specifies the capture_mode and exposure_ms parameters in the “captures” section of the initial configuration file used to configure node cap_node_1. The asset is packaged in a tar-ball file, asset_project_20080501_capture_preset_v1.tar.

```
/ / capture config-preset has one file: asset.json
{
  “type”:“capture-preset”,
  “id”:“asset_project_20080501_capture_preset_v1”,
  “capture-preset”: {
    “capture_mode”: “single_shot”,
    “exposure_ms”: 30
  }
}
```

A depth estimator configuration pre-set asset is also created and packaged in a tar-ball file, asset_project_20080501_depth_preset_v1.tar. This asset's GUID is “asset_project_20080501_depth_preset_v1” and its payload specifies the parameters (including the reliance on asset “asset_generic_depth_v1”) in the “depth_estimators” section of the initial configuration file used to configure node depth_node_1.

```
/ / depth config-preset has one file: asset.json
{
  “type”:“depth-preset”,
  “id”:“asset_project_20080501_depth_preset_v1”,
  “depth-preset”: {
    “depth_network”: “asset_generic_depth_v1”,
    “normalization”: “global”,
    “tile_dimension”: 200
  }
}
```

A part detector configuration pre-set asset is also created and packaged in a tar-ball file, asset_project_20080501_detector_preset_v1.tar. This asset's GUID is “asset_project_20080501_detector_preset_v1” and its payload specifies the parameters (including the reliance on asset “asset_project_20080501_detector_v2”) in the “part_detectors” section of the initial configuration file used to configure node detector_node_1.

```
/ / detector config-preset has one file: asset.json
{
  “type”:“detector-preset”,
  “id”:”asset_project_20080501_detector_preset_v1”,
  “detector-preset”: {
    “detector network”:
“asset_project_20080501_detector_v2”,
    “max_objects”: 4
  }
}
```

A pose estimator configuration pre-set asset is also created and packaged in a tar-ball file, asset_project_20080501_pose_preset_v1.tar. This asset's GUID is “asset_project_20080501_pose_preset_v1” and its payload specifies the parameters (including the reliance on asset “asset_project_20080501_part_a_cad_v1”) in the “pose_estimators” section of the initial configuration file used to configure node pose_node_1.

```
/ / pose config-preset has one file: asset.json
{
  “type”:“pose-preset”,
  “id”:“asset_project_20080501_pose_preset_v1”,
  “pose-preset”: {
    “model”: “asset_project_20080501_part_a_cad_v1”,
    “point_match_threshold”: 0.002
  }
}
```

A grip-planner configuration pre-set asset is also created and packaged in a tar-ball file, asset_project_20080501_grip_preset_v1.tar. The asset's GUID is “asset_project_20080501_grip_preset_v1” and its payload specifies the parameters in the “grip_planners” section of the initial configuration file used to configure node grip_planner_node_1.

```
/ / grip planner config-preset has one file: asset.json
{
  “type”:“grip-preset”,
  “id”:“asset_project_20080501_grip_preset_v1”,
  “grip-preset”: {
    “planner_type”: “simple”,
    “pick_point”: {
      “p_deg”: 90.0,
      “r_deg”: 0.0,
      “w_deg”: 0.0,
      “x_m”: −0.01,
      “y_m”: 0.0,
      “z_m”: 0.0
    }
  }
}
```

Based on the above configuration pre-set assets, the initial configuration file can be simplified into the following simplified version (“second configuration file”) of the initial configuration file in JSON format. In the second configuration file, the vision pipeline 600a is again defined in the “vision_pipelines” section, except in contrast to the initial configuration file the “capture”, “depth”, “part_detector”, “pose”, and “grip_planner” nodes respectively refer to the asset_project_20080501_capture_preset_v1, asset_project_20080501_depth_preset_v1, asset_project_20080501_detector_preset_v1, asset_project_20080501_pose_preset_v1, and asset_project_20080501_grip_preset_v1 configure pre-set assets. This has the effect of not requiring the customer to separately recite the configuration parameters pre-defined in the configuration pre-set assets in the “data-nodes” section of the second configuration file, thereby shortening and simplifying the second configuration file relative to the initial configuration file. In at least some examples, a system integrator can push the asset_project_20080501_capture_preset_v1, asset_project_20080501_depth_preset_v1, asset_project_20080501_detector_preset_v1, asset_project_20080501_pose_preset_v1, and asset_project_20080501_grip_preset_v1 configuration pre-set assets to the asset repository 114 for use by the customer without having the customer manually configure all the configuration parameters explicitly recited in the initial configuration file relative to the second configuration file, thereby streamlining deployment and/or troubleshooting.

```
{
  “vision_pipelines”: {
    “3d_pick_part_A”: {
      “type”: “3d_pose”,
      “capture”:
“asset_project_20080501_capture_preset_v1”,
      “capture.primary_camera_serial”: “123”,
      “capture.secondary_camera_serial”: “124”,
      “roi”: “roi_node_1”,
      “depth”: “asset_project_20080501_depth_preset_v1”,
      “part_detector”:
“asset_project_20080501_detector_preset_v1”,
      “pose”: “asset_project_20080501_pose_preset_v1”,
      “grip_planner”:
“asset_project_20080501_grip_preset_v1”,
    }
  },
  “data-nodes”: {
    “captures”: { },
    “rois”: {
      “roi_node_1”: {
        “roi_x”: 300,
        “roi_y”: 184,
        “roi_w”: 2302,
        “roi_h”: 3591
      }
    },
    “depth_estimators”: { },
    “part_detectors”: { },
    “pose_estimators”: { },
    “grip_planners”: { }
  },
  “robot_server”: {
    “port”: 14040,
    “robot_type”: “fanuc”
  }
}
```

The second configuration file can be further simplified into a third configuration file. For example, a system integrator can create a configuration pre-set asset representing the entire 3d_pick_part_A vision pipeline 600a except for the regions of interest and serial numbers of the first and second cameras 104a,b. A tar-ball file named asset_project_20080501_vision_pipeline_preset_v1.tar comprises a configuration pre-set asset having a GUID of “asset_project_20080501_vision_pipeline_preset_v1” and specifying the following nodes, including the asset_project_20080501_capture_preset_v1, asset_project_20080501_depth_preset_v1, asset_project_20080501_detector_preset_v1, asset_project_20080501_pose_preset_v1, and asset_project_20080501_grip_preset_v1 configuration pre-set assets. The asset_project_20080501_vision_pipeline_preset_v1 configuration pre-set asset can be pushed to the asset repository 114 for easy deployment across various systems 100 and/or vision processors 108a-c. The following is the asset.json file for the asset_project_20080501_vision_pipeline_preset_v1 configuration pre-set asset.

```
// vision pipeline config-preset as one file: asset.json
{
  “type”:“vision-pipeline-preset”,
  “id”:“asset_project_20080501_vision_pipeline_preset_v1”,
  “vision-pipeline-preset”: {
      “type”: “3d_pose”,
      “capture”:
“asset_project_20080501_capture_preset_v1”,
      “depth”: “asset_project_20080501_depth_preset_v1”,
      “part_detector”:
“asset_project_20080501_detector_preset_v1”,
      “pose”: “asset_project_20080501_pose_preset_v1”,
      “grip_planner”:
“asset_project_20080501_grip_preset_v1”,
    }
  }
}
```

With the asset_project_20080501_vision_pipeline_preset_v1 configuration pre-set asset, the third configuration file is simplified relative to the second configuration file by having the 3d_pick_part_A vision pipeline 600a defined by an explicit reference only to the asset_project_20080501_vision_pipeline_preset_v1 configuration pre-set asset, the serial numbers of the cameras 104a,b, and a reference to regions-of-interest that are specified later in the third configuration file.

```
{
  “vision_pipelines”: {
    “3d_pick_part_A”: {
“config_preset”:“asset_project_20080501_vision_pipeline_preset_v1”,
      “capture.primary_camera_serial”: “123”,
      “capture.secondary_camera_serial”: “124”,
      “roi”: “roi_node_1”
    }
  },
  “nodes”: {
    “captures”: { },
    “rois”: {
      “roi_node_1”: {
        “roi_x”: 300,
        “roi_y”: 184,
        “roi_w”: 2302,
        “roi_h”: 3591
      }
    } ,
    “depth_estimators”: { } ,
    “part_detectors”: { },
    “pose_estimators”: { },
    “grip_planners”: { }
  },
  “robot_server”: {
    “port”: 14040,
    “robot_type”: “fanuc”
  }
}
```

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

The robot controller 110 and vision processors 108a-c used in the foregoing embodiments may comprise, for example, a processing unit (such as a processor, microprocessor, or programmable logic controller) communicatively coupled to a non-transitory computer readable medium having stored on it program code for execution by the processing unit, microcontroller (which comprises both a processing unit and a non-transitory computer readable medium), field programmable gate array (FPGA), system-on-a-chip (SoC), an application-specific integrated circuit (ASIC), or an artificial intelligence accelerator. Examples of computer readable media are non-transitory and include disc-based media such as CD-ROMs and DVDs, magnetic media such as hard drives and other forms of magnetic disk storage, semiconductor based media such as flash media, random access memory (including DRAM and SRAM), and read only memory.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims.

One or more example embodiments have been described by way of illustration only. This description is being presented for purposes of illustration and description, but is not intended to be exhaustive or limited to the form disclosed. It will be apparent to persons skilled in the art that a number of variations and modifications can be made without departing from the scope of the claims.

1. A method comprising:
(a) obtaining a first image from a first camera; and
(b) processing the first image in a first vision pipeline, wherein the first vision pipeline comprises a first group of connected processing nodes, and at least one of the nodes relies on an asset to perform a processing task based on the first image.

2. The method of claim 1, further comprising moving a first robot in response to the processing performed by the first vision pipeline.

3. The method of claim 1 or 2, wherein the asset comprises a packaged file, the packaged file comprises an asset descriptor, and the asset descriptor comprises an asset identifier, an asset type identifier, and a payload.

4. The method of claim 3, wherein the payload comprises a neural network definition and associated weights.

5. The method of claim 3 or 4, wherein the payload comprises configuration parameters for the at least one of the nodes.

6. The method of any one of claims 3 to 5, wherein the configuration parameters comprise at least one other asset identifier identifying at least one other asset.

7. The method of claim 6, wherein the at least one other asset comprises additional configuration parameters for the at least one of the nodes.

8. The method of claim 6 or 7, wherein the configuration parameters of the payload further comprise non-asset identifier parameters.

9. The method of any one of claims 3 to 8, wherein the asset identifier is globally unique.

10. The method of any one of claims 1 to 9, further comprising processing the image in a second vision pipeline, wherein the second vision pipeline comprises a second group of connected processing nodes, wherein at least one of the nodes of the second group performs a processing task based on the first image, and wherein the second vision pipeline performs processing on an output of the first vision pipeline.

11. The method of any one of claims 1 to 9, further comprising processing the image in at least one additional vision pipeline, wherein each of the at least one additional vision pipeline comprises an additional group of connected processing nodes, wherein at least one of the nodes of each of the at least one additional vision pipeline performs a processing task based on the first image, and wherein the first vision pipeline and the at least one additional vision pipeline are connected in series.

12. The method of claim 10 or 11, wherein the vision pipelines are collectively identified using a chained pipeline identifier.

13. The method of any one of claims 1 to 9, further comprising processing the image in a second vision pipeline, wherein the second vision pipeline comprises a second group of connected processing nodes, wherein at least one of the nodes of the second group performs a processing task based on the first image or on a second image, and wherein the second vision pipeline performs processing on the first image or on the second image in parallel with the first vision pipeline.

14. The method of claim 13, wherein the first and second vision pipelines are collectively identified using a pipeline group identifier.

15. The method of any one of claims 1 to 9, further comprising processing the image in at least one additional vision pipeline, wherein each of the at least one additional vision pipeline comprises an additional group of connected processing nodes, wherein at least one of the nodes of each of the at least one additional vision pipeline performs a processing task based on the first image or on an image different from the first image, and wherein the first vision pipeline and the at least one additional vision pipeline are connected in parallel.

16. The method of claim 15, wherein the first vision pipeline and the at least one additional vision pipeline are collectively identified using a pipeline group identifier.

17. The method of any one of claims 1 to 16, wherein the processing is performed using a first vision processor, and wherein the asset is retrieved from an asset repository accessible by the first vision processor and at least one other vision processor.

18. The method of claim 17, wherein the asset repository stores at least one other asset for the at least one other vision processor.

19. The method of claim 17, wherein the asset is stored in a hashed path in the asset repository.

20. The method of claim 17, wherein the asset is one or both of encrypted and digitally signed when stored in the asset repository.

21. The method of any one of claims 1 to 20, wherein a configuration of the first vision pipeline is stored in a configuration file.

22. The method of claim 21, further comprising storing different versions of the configuration file respectively specifying different states of the assets at different times.

23. The method of claim 22, wherein the different versions of the configuration file are managed using at least a first distributed version control system.

24. The method of claim 22 or 23, further comprising:
(a) retrieving a version of the configuration file representing a past system configuration; and
(b) reverting to the past system configuration.

25. The method of claim 23, wherein the different versions of the configuration file that correspond to different schema for the configuration file are managed using the first distributed version control system and are respectively stored using different named-branches of the first distributed version control system.

26. The method of claim 25, further comprising retrieving a particular one of the different versions of the configuration file by checking out a tip of the named-branch used to store the particular one of the different versions of the configuration file.

27. The method of claim 25, wherein the first distributed version control system is stored in a local repository and the different versions of the configuration file are also managed using a second distributed version control system stored in a cloud repository, wherein the different versions of the configuration file managed using the second distributed version control system are respectively stored using different named-branches of the second distributed version control system and respectively correspond to different schema for the configuration file, and wherein the method further comprises:
(a) determining that a particular one of the different versions of the configuration file is unavailable in the local repository and available in the cloud repository; and
(b) retrieving the particular one of the different versions of the configuration file by checking out a tip of the named-branch of the second distributed version control system used to store the particular one of the different versions of the configuration file.

28. The method of claim 25, wherein none of the named-branches store a desired version of the configuration file, and further comprising:
(a) upgrading a schema of one of the different versions of the configuration file to the desired version of the configuration file;
(b) creating a new named-branch in the first distributed version control system; and
(c) committing the desired version of the configuration file as the new named-branch.

29. The method of claim 25, further comprising committing a new version of the configuration file as a new commit of an existing one of the named-branches of the first distributed version control system, wherein a commit author of the new commit is based on an identity of a system user and on an identity of a representative of the system manufacturer.

30. The method of claim 29, further comprising pushing the new commit to a second distributed version control system residing in a cloud repository.

31. The method of claim 17, wherein the asset repository is stored as a cloud repository and wherein different versions of the assets are stored in the cloud repository.

32. The method of any one of claims 21 to 31, further comprising maintaining a journal log of system launch configurations, wherein the journal log for each of the system launch configurations comprises a software version, a commit hash of a configuration repository, a duration of each run, and whether the software initialized completely.

33. The method of claim 32, further comprising:
(a) retrieving one of the system launch configurations representing a past system launch configuration; and
(b) reverting to the past system launch configuration.

34. The method of any one of claims 21 to 24, wherein at least two of the nodes of the first vision pipeline are collectively referenced in the configuration file as a pre-configured asset.

35. The method of claim 34, wherein all of the nodes of the first vision pipeline are collectively referenced in the configuration file as the pre-configured asset.

36. The method of any one of claims 1 to 35, further comprising:
(a) receiving from a robot controller a call to perform the processing;
(b) receiving from the robot controller a first identifier of one of the nodes; and
(c) returning to the robot controller an output of the node identified by the first identifier that results from the processing.

37. The method of claim 36, wherein the node identified by the first identifier is upstream of a final node of the vision pipeline, and further comprising:
(a) receiving from the robot controller a second identifier identifying the final node; and
(b) returning to the robot controller an output of the final node that results from the processing.

38. A system comprising:
(a) a first camera;
(b) a vision processor communicatively coupled to the first camera and to obtain a first image therefrom;
(c) a robot; and
(d) a robot controller communicatively coupled to the robot and to the vision processor, wherein the robot controller is configured to cause the vision processor to perform the method of any one of claims 1 to 37.

39. A non-transitory computer readable medium having encoded thereon computer program code that is executable by a processor and that, when executed by the processor, causes the processor to perform the method of any one of claims 1 to 37.

40. A method comprising storing in or retrieving from a first configuration file repository a version of a configuration file for a configurable system, wherein the first configuration file repository stores at least some different versions of the configuration file using a first distributed version control system that respectively stores different versions of the configuration file that correspond to different schema for the configuration file in different named-branches of the first distributed version control system.

41. The method of claim 40, wherein a version of the configuration file representing a past configuration of the configurable system is retrieved, and further comprising reverting the configurable system to the past system configuration.

42. The method of claim 40, wherein a particular one of the different versions of the configuration file is retrieved from the repository by checking out a tip of the named-branch used to store the particular one of the different versions of the configuration file.

43. The method of claim 40, wherein the first configuration file repository is a local repository and the different versions of the configuration file are also managed using a second distributed version control system stored in a cloud repository, wherein the different versions of the configuration file managed using the second distributed version control system are respectively stored using different named-branches of the second distributed version control system and respectively correspond to different schema for the configuration file, and wherein the method further comprises:
(a) determining that a particular one of the different versions of the configuration file is unavailable in the local repository and available in the cloud repository; and
(b) retrieving the particular one of the different versions of the configuration file by checking out a tip of the named-branch of the second distributed version control system used to store the particular one of the different versions of the configuration file.

44. The method of claim 40, wherein none of the named-branches store a desired version of the configuration file, and further comprising:
(a) upgrading a schema of one of the different versions of the configuration file to the desired version of the configuration file;
(b) creating a new named-branch in the first distributed version control system; and
(c) committing the desired version of the configuration file as the new named-branch.

45. The method of claim 40, further comprising committing a new version of the configuration file as a new commit of an existing one of the named-branches of the first distributed version control system, wherein a commit author of the new commit is based on an identity of a user of the configurable system and on an identity of an administrator of the configuration repository.

46. The method of claim 45, further comprising pushing the new commit to a second distributed version control system residing in a cloud repository.

47. A system comprising:
(a) a processor;
(b) a network interface communicatively coupled to the processor;
(c) a memory communicatively coupled to the processor, the memory having computer program code stored thereon that is executable by the processor and that, when executed by the processor, causes the processor to perform the method of any one of claims 40 to 46.

48. A non-transitory computer readable medium having encoded thereon computer program code that is executable by a processor and that, when executed by the processor, causes the processor to perform the method of any one of claims 40 to 46.
